(19) United States
(12) Patent Application Publication
(10) Pub. No.: US 2021/0383243 A1
(43) Pub. Date: Dec. 9, 2021

(54) STABLE AND EFFICIENT TRAINING OF ADVERSARIAL MODELS BY AN ITERATED UPDATE OPERATION OF SECOND ORDER OR HIGHER

(71) Applicant: DeepMind Technologies Limited, London (GB)

(72) Inventors: Chongli Qin, London (GB); Yan Wu, St Albans (GB)

(21) Appl. No.: 17/337,376

(22) Filed: Jun. 2, 2021

Related U.S. Application Data
(60) Provisional application No. 63/034,356, filed on Jun. 3, 2020.

(51) Int. Cl. G06N 3/08; G06N 3/04

(52) U.S. Cl. CPC G06N 3/088; G06N 3/0454

(57) ABSTRACT

The training of an adversarial model is performed by respective update operations at each of a set of successive time steps to minimize an objective function having a plurality of loss components. The update operation includes at least one intermediate step of using gradients of the loss components for current values of the numerical parameters to generate intermediate values for the numerical parameters. A different set of intermediate values for each of the numerical parameters may be generated in each intermediate step. The update operation further includes generating respective updates to the current values of each of the numerical parameters based on functions of the gradients of at least one of the loss components with respect to the respective numerical parameters. This is done both for the current values of the numerical parameters and for the intermediate values of the numerical parameters.

### CROSS REFERENCE TO RELATED APPLICATION

This application claims priority to U.S. Provisional Application No. 63/034,356, filed Jun. 3, 2020, the contents which are incorporated by reference herein.

### BACKGROUND

This specification relates to methods and systems for training adversarial models such as ones incorporating a plurality of neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

Adaptive models are typically defined by a plurality of numerical parameters, which are iteratively adapted during a training phase of the adaptive model. Many adaptive models are trained by optimizing the numerical parameters of the model with respect to an objective function, for example by using an algorithm such as back propagation. The objective function typically includes a single loss component (a term evaluated based on a set of multiple training examples and indicative of the ability of the adaptive model to process the training examples), and may further comprise a regularization component.

However, certain adaptive models, referred to here as adversarial models, are trained to minimize an objective function including a plurality of loss components. Optimizing one of the loss components with respect to the numerical parameters moves another of the loss components away from its optimal value, so that the two loss components are in effect in competition with each other. Often adversarial models contain multiple neural networks, and the different loss components encode different tasks which corresponding ones of the neural networks are intended to perform. Thus, the neural networks may be competing with each other, and the training process may be a process of adaptation by the multiple neural networks to outmatch the others.

This specification generally describes how a system implemented as computer programs in one or more computers in one or more locations can perform a method to train (that is, adjust the parameters of) an adversarial model incorporating one or more neural networks, and defined based on a plurality of numerical components.

In general terms, the disclosure proposes that the training of an adversarial model is performed by respective update operations at each of a set of successive time steps (which may be labelled by successive values of an integer variable k) to minimize an objective function having a plurality of loss components. The update operation includes at least one intermediate step of using gradients of the loss components for current values of the numerical parameters to generate intermediate values for the numerical parameters. A different set of intermediate values for each of the numerical parameters may be generated in each intermediate step. The update operation further includes generating respective updates to the current values of each of the numerical parameters based on functions of the gradients of at least one of the loss components with respect to the respective numerical parameters. These gradients are evaluated both for the current values of the numerical parameters and for the intermediate values of the numerical parameters.

This training procedure may make it possible for the update operation to the current parameters to implement a second order update—that is the update operation numerically approximates an updating of the numerical parameters based on the second derivative of the loss components. The training procedure is analogous to a second order Runge-Kutta method for solving differential equations.

If there are multiple intermediate steps of generating intermediate values, each but the first using intermediate values generated in a preceding one of the intermediate steps, then the update to the current parameters may implement an update of higher than second order, such as a fourth order update. The training procedure is analogous to a higher order Runge-Kutta method for solving differential equations.

One of more of the numerical parameters, constituting a first proper subset of the numerical parameters, are referred to as first numerical parameters, and one of more of the numerical parameters, constituting a second proper subset of the numerical parameters, are referred to as second numerical parameters. The subsets do not overlap (i.e. all the first numerical parameters are different from—and typically independent of—all the second numerical parameters). At least one, and preferably all, of the loss components are functions of both the first and second numerical parameters. The first numerical parameters may be designated by the vector θ and the second numerical parameters may be designated by the vector ϕ. Thus, the current numerical parameters at the start of the update operation performed at time step k, may be denoted by the vector (θₖ, ϕₖ), that is a vector composed of the vector θₖ concatenated with the vector ϕₖ.

In at least one of the intermediate steps (typically the first intermediate step if there are a plurality of intermediate steps), the intermediate values of the each of the first numerical parameters may be generated based on the respective gradient with respect to that first numerical parameter of a first of the loss components for the current values of the numerical parameters (but not based on a gradient of the other loss component(s)). Similarly, in this at least one of the intermediate steps, the intermediate values of each of the second numerical parameters may be generated based on the respective gradient with respect to that second numerical parameter of a second of the loss components for the current values of the numerical parameters (but not based on a gradient of the other loss component(s)).

Anticipating an example of the adversarial model discussed below, we may designate the first loss component as l_{D} and the second loss component as l_{G}. Both may be functions of both θ and ϕ. In some cases they may encode respective tasks for respective neural networks of the adversarial model defined respectively by the first and second numerical parameters. An overall loss function for the learning may be denoted [l_{D}, l_{G}], the sum of the two loss components, and overall loss function may be comprise other components too.

In one example, in the first intermediate step: each first intermediate value is derived by adjusting the current value of the first numerical parameter by a respective amount indicative of the gradient of the first loss component with respect to the first numerical parameter for the current values of the numerical parameters, and each second intermediate value is derived by adjusting the current value of the second numerical parameter by a respective amount indicative of the gradient of the second loss component with respect to the second numerical parameter for the current values of the numerical parameters. To put this mathematically, the first intermediate step may generate the set of first and second intermediate values (\tilde{θ}ₖ, \tilde{ϕ}ₖ) for the numerical parameters given by:

$$( \begin{matrix}{θ}_{k} \\ {ϕ}_{k}\end{matrix} ) + hv ( {θ}_{k} , {ϕ}_{k} ) \qquad ( 1 )$$

where the vector v(θₖ, ϕₖ) is given by

$$- ( α \frac{\partial {l}_{D}}{\partial θ} , β \frac{\partial {l}_{G}}{\partial ϕ} ) \qquad ( 2 )$$

evaluated when the vectors θ, ϕ are the current values of the first and second numerical parameters (θₖ, ϕₖ). Here α and β are optional constants (that is, either or both may be equal to one), and h is a value which may be constant for all time steps, referred to as the “step size”.

In the case that there are a plurality of said intermediate steps (i.e. additional intermediate steps after the first intermediate step), each of the intermediate steps except the first intermediate step comprises evaluating the gradient of the first loss component with respect to the first numerical parameters and the gradient of the second loss component with respect to the second numerical parameters, with the evaluations being performed for the intermediate values of the first and second numerical parameters generated in one or more of the preceding one(s) of the intermediate steps, such as the immediately preceding intermediate step.

The update for each first numerical parameter is a sum of a term indicative of the gradient of the first loss component with respect to the first numerical parameter for the current values of the numerical parameters, and, for each of the intermediate steps, a term indicative of the gradient the first loss component with respect to the first numerical parameter for the corresponding intermediate values of the numerical parameters (i.e. the first intermediate values of the numerical parameters produced in that intermediate step); and the update for each second numerical parameter is a sum of a term indicative of the gradient of the second loss component with respect to the second numerical parameter for the current values of the numerical parameters, and, for each of the intermediate steps, a term indicative of the gradient of the second loss component with respect to the second numerical parameter for the corresponding intermediate values of the numerical parameters.

Taking for example the case that there is only one intermediate step in the update operation, the update for each first numerical parameter is indicative of the average of (i) the gradient of the first loss component with respect to the first numerical parameter for the current values of the numerical parameters, and (ii) the gradient the first loss component with respect to the first numerical parameter for the set of intermediate values of the numerical parameters; and the update for each second numerical parameter is indicative of the average of (i) the gradient of the second loss component with respect to the second numerical parameter for the current values of the numerical parameters, and (ii) the gradient the second loss component with respect to the first numerical parameter for the set of intermediate values of the numerical parameters. This may be expressed mathematically as:

$$( \begin{matrix}{θ}_{k + 1} \\ {ϕ}_{k + 1}\end{matrix} ) = ( \begin{matrix}{θ}_{k} \\ {ϕ}_{k}\end{matrix} ) + \frac{h}{2} ( v ( {θ}_{k} , {ϕ}_{k} ) + v ( {\tilde{θ}}_{k} , {\tilde{ϕ}}_{k} ) ) \qquad ( 3 )$$

where \tilde{θ}ₖ and \tilde{ϕ}ₖ are the first intermediate values given by Eqn. (1).

To provide higher order updates, there may be a plurality of intermediate steps (e.g. an odd number of intermediate steps, such as three intermediate steps). In each intermediate step but the first, each first intermediate value is derived by adjusting the current value of the first numerical parameter by a respective amount indicative of the gradient of the first loss component with respect to the first numerical parameter for the set of intermediate values of the numerical parameters derived in the preceding intermediate step, and each second intermediate value is derived by adjusting the current value of the second numerical parameter by a respective amount indicative of the gradient of the second loss component with respect to the second numerical parameter for the set of intermediate values of the numerical parameters derived in the preceding intermediate step

Specifically, in the case in which there are three intermediate steps (a case broadly similar to a Runge Kutta method of order 4), the update for each first numerical parameter may be indicative of the average of (i) the gradient of the first loss component with respect to the first numerical parameter for the current values of the numerical parameters, (ii) twice the gradient the first loss component with respect to the first numerical parameter for the first set of intermediate values of the numerical parameters (derived in the first intermediate step), (iii) twice the gradient the first loss component with respect to the first numerical parameter for the second set of intermediate values of the numerical parameters (derived in the second intermediate step); and (iv) the gradient the first loss component with respect to the first numerical parameter for the third set of intermediate values of the numerical parameters (derived in the third intermediate step). Similarly, the update for each second numerical parameter is indicative of the average of (i) the gradient of the second loss component with respect to the second numerical parameter for the current values of the numerical parameters, (ii) twice the gradient the second loss component with respect to the second numerical parameter for the first set of intermediate values of the numerical parameters, (iii) twice the gradient the second loss component with respect to the second numerical parameter for the second set of intermediate values of the numerical parameters; and (iv) the gradient the second loss component with respect to the second numerical parameter for the third set of intermediate values of the numerical parameters.

Experimentally it has been found that the stability of convergence to the Nash equilibrium is improved if regularization is employed. For this purpose, the update process further comprises a regularization update, to at least one of the first numerical parameters and the second numerical parameters, which tends to modify the evolution of the numerical parameters to avoid regions of the parameter space for which the gradients of the loss components are high.

In one example, the regularization update may be performed by subtracting a corresponding regularization amount from the first numerical parameters and/or second numerical parameters. This may be done following the step of updating the current values of the first and second numerical parameters by the corresponding updates, i.e. the regularization update is performed by subtracting a respective regularization amount from the updated first numerical parameters and/or updated second numerical parameters.

The regularization amount may be a positive number. It may be indicative, in the case of the first numerical parameters, of the magnitude of gradient of the first loss component with respect to the first numerical parameters evaluated at the current numerical parameters (i.e. their values prior to their update). It may be indicative, in the case of the second numerical parameters, of the magnitude of the gradient of the second loss component with respect to the second numerical parameters evaluated using the current values of the numerical parameters (i.e. their values prior to their update).

The regularization amount, in the case of the first numerical parameters, may be proportional to the square of the magnitude of the gradient of the first loss component with respect to the first numerical parameters evaluated at the current numerical parameters (i.e. the sum over the first numerical parameters, of the respective squares of the respective gradients of the first loss component with respect to the respective first numerical parameters, evaluated for the numerical parameters prior to the update). In the case of the second numerical parameters, it may be proportional to the square the magnitude of the gradient of the second loss component with respect to the second numerical parameters evaluated at the current numerical parameters (i.e. the sum over the second numerical parameters, of the respective squares of the respective gradients of the second loss component with respect to the respective second numerical parameters, evaluated for the numerical parameters prior to the update).

The adversarial model may be any type of adversarial model. In particular, it may be selected from the group including generative adversarial networks (GANs), proximal gradient TD learning, multi-level optimization (Pfau and Vinyals, 2016), synthetic gradients (Jaderberg et al, 2017), hierarchical reinforcement learning (Wayne and Abbot, 2014; Vezhnevets et al, 2017), curiosity networks (as proposed by Pathak et al 2017), and imaginative networks (as proposed by Racaniere et al, 2017). These will be considered in turn. Typically, these adversarial models contain a plurality of neural networks and they are trained by an objective function which causes these networks to compete against each other. The training is typically designed to reach the Nash equilibrium for this competition. Inputs to at least one of the neural networks of the adversarial network may be data obtained from the real world (e.g. sensor data from a sensor such as a camera or video camera, or sound captured by a microphone) or samples of natural language (e.g. in written form). Similarly, outputs from at least one of the neural networks of the adversarial network may be control data to influence the real world (e.g. to control at least one agent in the real world such as an electromechanical agent moving (by translation and/or change of configuration) in the real world), and/or images and/or sound data, or samples of natural language (e.g. in written form).

A Generative Adversarial Network (GAN) comprises a generative neural network (or “generator”; the terms are used interchangeably here), and a discriminator neural network. The generative neural network is trained, based on a training set of data items (“samples”) selected from a distribution (a “sample distribution”), to generate samples from the distribution. The generative neural network, once trained, may be used to generate samples from the sample distribution based on latent values (or simply “latents”) selected from a latent value distribution (or “latent distribution”). The discriminator neural network is configured to distinguish between samples generated by the generative neural network and samples of the distribution which are not generated by the generative neural network.

The first numerical parameters θ may be the parameters of the discriminator network, and the second numerical parameters ϕ may be the parameters of the generative neural network. The first loss component as l_{D} may be defined such that minimizing the first loss component l_{D} with respect to the first parameters corresponds to maximizing a measure of a difference between (i) an average over the distribution of the latent values of a term indicative of the output of the discriminator network upon receiving as an input the output of the generative neural network generated based on the latent values, and (ii) an average over a training set of data items of a term indicative of the output of the discriminator network upon receiving as an input a data item from the training set. Conversely, minimizing the second loss component l_{G} with respect to the second parameters corresponds to minimizing said measure of the difference

Many types of GAN network are known to which the present training process is applicable. For example, in some GAN networks the adaptive system further comprises an encoder for generating sets of latent values upon receiving as an input a sample. The encoder may be trained jointly with the generative neural network and the discriminator network. However, for simplicity, we will here refer only to the training of the generative neural network and discriminator network.

Furthermore, the generator may optionally receive conditioning data together with the latent values which indicate which of a plurality of predetermined classes the sample generated by the generator should be in. In this case, typically the discriminator too typically receives the conditioning data. Alternatively, the conditioning data may be considered a portion of the latent values of the generator which is also typically supplied to the discriminator.

In implementations, it has been found that using the second or higher order update operations described above, generator and discriminator neural networks can be trained effectively and efficiently, because it is possible to achieve reliable and fast convergence towards the Nash equilibrium, which is often not the case for known training algorithms. This may allow data to be processed more effectively than in known methods.

For example, a known problem of training GANs (and analogous problems exist for the other types of adversarial models mentioned above) is “mode collapse”. Typically, it is desired that the GAN produces a wide variety of outputs upon receiving latents from the latent distribution. However, it may happen, for certain known GAN training algorithms, that the generator produces a data item which is very close to one of the data items in the training set, and the discriminator may be unable to distinguish the data item created by the generator from a data item which was not created by the discriminator. “Mode collapse” refers to a phenomenon in which the generator learns always to generate the same data item irrespective of the latent values, or always to generate one of a small number of data items which the discriminator has difficulty distinguishing from data items in the training set.

In this situation, the discriminator may achieve the best results by always rejecting the output of the generator, but the discriminator may not find that best strategy (for example because it is stuck in a local minimum). Thus, the discriminator may fail to learn its way out of the trap, and the entire system fails to converge to a Nash equilibrium. For example, the generator and discriminator may “rotate”, that is cycle, though a small respective set of states. In each of these states of the generator, it produces one of the small number of data items adapted to the current state of the discriminator.

Experimentally, it has been found that this problem is substantially eliminated in some forms of the presently disclosed system. This is because stable cycles in the training trajectory are at least reduced, and may be substantially eliminated.

In the case that the regularization update described above is included in the update process, it may be performed to the second numerical parameters, i.e. to the parameters of the generator based on the gradient of the generator loss component with respect to the second numerical parameters.

The subject matter described in this specification can be implemented in particular embodiments so as to realize one or more of the following advantages.

The training method enables the use of larger scale generator which can model more complex data distributions to be trained effectively and efficiently. Given the overall improved training speed, the training method requires fewer computational resources such as processor time and power usage to complete training.

In implementations the latent values (in the case they include conditioning data) can provide a representation of the data items on which the system was trained which tend to capture the high level semantics of the data items rather than their low level detail. Thus the latent values may naturally capture the “categories” of the data items, despite being trainable using unlabeled data. This vastly expands the amount of training data items potentially available, and hence the detailed semantics which may be captured.

A second type of adversarial model to which the present techniques can be applied is an actor-critic model, which is sometimes employed in reinforcement learning. In a reinforcement learning method an action selection policy neural network may receive an observation of an environment e.g. a real-world environment where the observation is obtained from a sensor (e.g. a camera or microphone), and select an action to be performed by an agent e.g. a mechanical agent such as a robot, in response. The learning is according to a reward signal from the environment in response to the action. The aim of actor-critic models is to simultaneously learn an action value function Qπ (s, a) that predicts the expected discounted reward, and learn a policy that is optimal for that value function.

More specifically, the actor-critic adversarial model may contain first and second neural networks. The first neural network may comprise the action selection policy neural network, and the second neural network may comprise a neural network configured to provide a value for use in training the first neural network. For example the second neural network may comprise a value function neural network (e.g. estimating a predicted, time-discounted reward) and the first neural network may be configured to learn an action selection policy dependent on a value provided by the value function neural network. In another example the second neural network may comprise a manager neural network which selects between action selection policy neural networks to perform a task. In a third example the second neural network may comprise a neural network which learns an intrinsic reward for use in training the first neural network.

Various specific learning techniques have been developed which are suitable for use in this system, and the present techniques can be employed to perform the training process.

A specific type of adversarial model for which the present techniques can be employed is proximal gradient TD learning, as proposed by Lu, X. Hamiltonian games. Journal of Combinatorial Theory, Series B, 55:18-32, 1992

Another specific type of adversarial model for which the present techniques can be employed is multi-level optimization (Pfau and Vinyals, 2016), particularly for an adversarial system which is an actor-critic model.

Another specific type of adversarial model for which the present techniques can be employed is synthetic gradients (Jaderberg et al, 2017). This uses a modelled synthetic gradient in place of true backpropagated error gradients to decouple subgraphs, and update them independently and asynchronously. It thus realises decoupled neural interfaces—resulting in models which are decoupled in both the forward and backwards pass—amounting to independent networks which co-learn such that they can be composed into a single functioning corporation.

Another specific type of adversarial model for which the present techniques can be employed is hierarchical reinforcement learning (Wayne and Abbot, 2014; Vezhnevets et al, 2017). This addresses a technical situation in which a low-level controller directs the activity of a “plant,” a system that performs a task. The low-level controller may be able to solve only fairly simple problems involving the plant. To accomplish more complex tasks, these papers propose a higher-level controller that controls the lower-level controller. The top-level controller in such a hierarchy receives an external command that specifies the overarching task objective, whereas the bottom-level controller issues commands that actually generate actions. This enables two levels of control using the lower-level and higher-level controllers. Each controller receives input describing the goal it is to achieve and “sensory” input providing information about the environment relevant to achieving this goal. Its output is the command specifying the goal for the controller one level down in the hierarchy. The two controllers may be implemented as neural networks. A manager neural network selects primitive actions or options selected by an option neural network; an option is a sequence of actions—e.g. a call-and-return model. The manager can learn to perform the task by itself without using the options.

Another specific type of adversarial model for which the present techniques can be employed are curiosity networks (as proposed by Pathak et al 2017). In this case reinforcement learning is performed using “curiosity” as an intrinsic reward signal to enable an agent to explore its environment and learn skills that might be useful later in its life. Curiosity is formulated as the error in an agent's ability to predict the consequence of its own actions in an environment. The environment may be a visual feature space learned by a self-supervised inverse dynamics model. The system learns feature representations such that the prediction error in the learned feature space provides a good intrinsic reward signal.

Another specific type of adversarial model for which the present techniques can be employed are imaginative networks (as proposed by Racaniere et al, 2017). In contrast to most existing model-based reinforcement learning and planning methods, which prescribe how a model should be used to arrive at a policy, imaginative networks learn to interpret predictions from a learned environment model to construct implicit plans in arbitrary ways, by using the predictions as additional context in deep policy networks.

In order to augment model-free agents with imagination, imaginative networks rely on environment models—models that, given information from the present, can be queried to make predictions about the future. The imaginative network uses these environment models to simulate imagined trajectories, which are interpreted by a neural network and provided as additional context to a policy network.

### BRIEF DESCRIPTION OF THE DRAWING

The details of one or more embodiments of the subject matter of this specification are set forth in the accompanying drawings and the description below. Other features, aspects, and advantages of the subject matter will become apparent from the description, the drawings, and the claims.

FIG. 1 is a diagram of an example training system for training a generative neural network.

FIG. 2 is a flow diagram of an example process for training a generative neural network.

FIG. 3 illustrates a possible implementation of a step of the process of FIG. 2.

### DETAILED DESCRIPTION

This specification describes a system that trains an adversarial model. One example of an adversarial model is a generative adversarial network (GAN). The system can train the generative neural network in an adversarial manner using a discriminator neural network system that includes one or more discriminators.

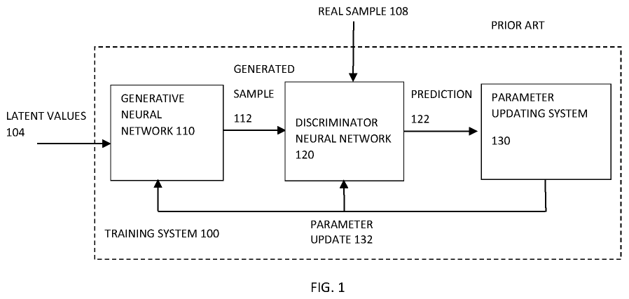

FIG. 1 is a diagram of an example training system 100 for training a generative neural network 110. The training system 100 is an example of a system implemented as computer programs on one or more computers in one or more locations, in which the systems, components, and techniques described below can be implemented.

The training system 100 includes a generative neural network 110, a discriminator neural network 120, and a parameter updating system 130. The training system 100 is configured to train the generative neural network 110 to generate a sample 112. In some implementations, the generative neural network 110 is a feedforward neural network, i.e., the generative neural network 110 generates the sample 112 in a single forward pass.

The generated sample 112 is intended to mimic real samples chosen from a distribution. (a “sample distribution”). For example, the real samples may be images (e.g. image captured using a camera) which are randomly sampled from an image distribution. Alternatively, the real samples may be sections of sound (e.g. voice samples) which are randomly sampled from an audio distribution. For example, the real sample can include, for each output time step, an amplitude value of the audio wave. In some implementations, the amplitude value can be a compressed or companded amplitude value. Alternatively, the real samples may be sections of video which are randomly sampled from a video distribution.

The generative neural network 110 (“generator”) receives as input at each time step one or more latent values 104. For example, the latent values 104 can be randomly sampled from a predetermined “latent distribution”, e.g., a normal distribution. The latent values 104 can ensure variability in the generated sample 112. Optionally, the latent values may include conditioning data, e.g. a component of the latent values which indicates one of a set of predetermined classes.

After the generative neural network 110 generates the generated sample 112, the training system 100 can provide the generated sample 112 to the discriminator neural network 120. The training system 100 can train the discriminator neural network 120 to process a sample it receives, and to generate a prediction 122 of whether the sample is real, i.e. a sample which is truly selected from the sample distribution, or synthetic, i.e., a sample that has been generated by the generative neural network 110.

The discriminator 120 is also configured to receive “real” samples 108, sampled from the sample distribution. In practice, the system may use a training database of real samples (“training set”), and may evaluate the performance of the generative neural network 110 and discriminator neural network 120 using a (e.g. random) mini-batch of the real samples.

The discriminator neural network 120 can have any appropriate neural network architecture. As a particular example, the discriminator neural network system 120 can include one or more discriminators that each process the sample 112 and predict whether the sample 112 is real or synthetic. Each discriminator may include a sequence of groups of convolutional neural network layers, called “discriminator blocks.”

Optionally (and not shown in FIG. 1) the discriminator neural network 120 may further receive any conditioning data which is part of the latent values 104 and which characterizes the generated sample. For example, if the sample distribution includes images in a plurality of classes (e.g. in the case of an image distribution the classes may be: images of dogs; images of mountains; images of vehicles), the conditioning data may specify which of these classes the generated sample 112 is intended to be in. In another example, if the sample distribution is an audio distribution, the conditioning data may be an input text, and generated sample 112 may be an audio output which depicts speech corresponding to the input text. For example, the audio output may be a speech waveform which may be suitable for transmission to a speaker unit to generate a sound waveform. Thus, the generative neural network 110 operates as a text-to-speech converter. In some implementations, the conditioning input includes the input text itself, e.g., character-level of word-level embeddings of the input text. Instead or in addition, the conditioning input may include linguistic features characterizing the text input. For example, the conditioning input can include a respective vector of linguistic features for each input time step in a sequence of input time steps. As a particular example, the linguistic features for each input time step can include i) a phoneme and ii) a duration of the text at the input time step. The linguistic features can also include pitch information; for example, the pitch can be represented by a logarithmic fundamental frequency log F₀ of the input time step. Alternatively or additionally, the conditioning data may identify a particular speaker that the generated audio output should sound like. That is, the audio output may sound like the particular speaker speaking the input text. In the case that the generative neural network 110 receives conditioning data, the discriminator neural network 120 may optionally receive, with each generated sample 112, the conditioning data it was based on. Furthermore, in this case, when the discriminator neural network 120 receives one of the real samples 108 it typically also receives a corresponding conditioning input characterizing the real sample 108.

In some implementations, the one or more discriminators of the discriminator neural network 120 include one or more conditional discriminators and one or more unconditional discriminators. The conditional discriminators receive as input i) the sample 112 generated by the generative neural network 110 and ii) the conditioning data that the generative neural network 110 used to generate the sample 112. The unconditional discriminators receive as input the sample 112 generated by the generative neural network 110, but do not receive as input the conditioning input. Thus, the conditional discriminators can measure how well the sample 112 corresponds to the class characterized by the conditioning input in addition to measuring the general realism of the generated sample 112 (i.e. its resemblance to a random sample from the sample distribution), whereas the unconditional discriminators only measure the general realism of the generated sample 112.

The discriminator neural network 120 can combine the respective predictions of the one or more discriminators to generate the prediction 122.

The parameters of the discriminator neural network 120 are referred to as “first numerical parameters”, which may be designated by the vector θ. The parameters of the generative neural network 110 are referred to as “second numerical parameters” which may be designated by the vector ϕ. Training the network thus refers to iteratively optimizing the values (θ, ϕ). This is done in iterations at time steps labelled by an integer index k. Thus, the current numerical parameters at the start of the update operation performed at time step k, may be denoted by the vector (θₖ, ϕₖ), that is a vector composed of the vector θₖ concatenated with the vector ϕₖ.

The real samples 108 will be denoted by x which is selected from a sample distribution p(x), that is x˜p(x). The latent values 104 are denoted by z which is selected from a latent distribution p(z), that is z˜p(z). In the following discussion for simplicity of notation the possibility of the generative neural network and discriminator neural network receiving additional conditioning data is neglected (i.e. the explanation assumes that there is only a single class of real samples 108), though it is straightforward to generalize the discussion to incorporate it.

The parameter updating system 130 can obtain the prediction 122 generated by the discriminator neural network system 120 and determine a parameter update 132 according to an error in the prediction 122 (i.e. a misclassification of the sample 112 by the discriminator neural network 120). The training system can apply the parameter update 132 to the parameters of the generative neural network 110 and the discriminator neural network 120. That is, the training system 100 can train the generative neural network 110 and the discriminators in the discriminator neural network 120 concurrently (e.g. by substantially simultaneous updates of the parameters of the generative neural network 110 and the discriminators in the discriminator neural network, or interleaved updates to the parameters of the generative neural network 110, and to the parameters of the discriminator neural network).

Generally, the parameter updating system 130 determines the parameter update 132 to the parameters of the generative neural network 110 in order to increase the error in the prediction 122. For example, if the discriminator neural network system 120 correctly predicted that the generated sample 112 is synthetic, then the parameter updating system 130 generates a parameter update 132 to the parameters of the generative neural network 110 in order to improve the realism of the generated sample 112 so that the discriminator neural network system 120 might incorrectly predict the next generated sample 112 to be real (i.e. randomly selected from the sample distribution).

Conversely, the parameter updating system 130 determines the parameter update 132 to the parameters of the discriminator neural network 120 in order to decrease the error in the prediction 122. For example, if the discriminator neural network 120 incorrectly predicted that the generated sample 112 is real, then the parameter updating system 130 generates a parameter update 132 to the parameters of the discriminator neural network 120 in order to improve the predictions 122 of the discriminator neural network 120.

During training, the training system 100 can also provide real samples 108 to the discriminator neural network 120. Each discriminator in the discriminator neural network system 120 can process the real sample 108 to predict whether the real sample 108 is a real or synthetic sample from the sample distribution. Again, the discriminator neural network 120 can combine the respective predictions of each the discriminators to generate a second prediction 122. The parameter updating system 130 can then determine a second parameter update 132 to the parameters of discriminator neural network 120 according to an error in the second prediction 122. Optionally, the training system 100 does not use the second prediction corresponding to the real sample 108 to update the parameters of the generative neural network 110.

As a particular example, parameter updating system 130 can use the Wasserstein loss function to determine the parameter update 132, which is:

D(x;θ)−D(G(z;ϕ);θ),

where D(x; θ) is the likelihood assigned by the discriminator neural network system 120 that a real sample 108 is real, G(z; ϕ) is a generated sample 112 (which may be denoted \hat{x}) generated by the generative neural network 110, and D(G(z; ϕ); θ) is the likelihood assigned by the discriminator neural network system 120 that the generated sample 112 is real. The objective of the generative neural network 110 is to minimize Wasserstein loss by maximizing D(G(z; ϕ); θ), i.e. by causing the discriminator neural network system 120 to predict that a generated sample 112 is real. The objective of the discriminator neural network system 120 is to maximize Wasserstein loss, i.e. correctly recognize both real and generated samples as such.

As another particular example, the parameter updating system 130 can use the following loss function:

log(D(x;θ))+log(1−D(G(z;ϕ);θ))

where again the objective of the generative neural network 110 is to minimize the loss and the objective of the discriminator neural network 120 is to maximize the loss.

Furthermore, the loss function may be an average over the sample distribution p(x) and the latent distribution p(z), where these averages are typically evaluated by considering many possible realizations of real samples x and latent values z. Thus, the loss function may be:

[symbol]

(θ,ϕ)= [symbol] _{x˜p(x)}[log(D(x;θ))]+ [symbol] _{z˜p(z)}[log(1−D(G(z;ϕ));θ))] (4)

where [symbol] _{x˜p(x)} [g(x)] stands for the expected value of a function g(x) given the distribution x˜p(x). Training is thus finding the (θ, ϕ) which is max_{θ}min_{ϕ} [symbol] (θ, ϕ). In some cases, the problem is transformed into one in which the objective function is asymmetric, e.g.

[symbol]

(θ,ϕ)= [symbol] _{x˜p(x)}[log(D(x;θ))]+ [symbol] _{z˜p(z)}[−log(D(G(z;ϕ));θ))]

In a general form which covers all these possible loss functions, the overall loss function (objective function) of the discriminator-generator pair can be denoted by:

l(θ,ϕ)=[l_{D}(θ,ϕ),l_{D}(θ,ϕ)] (5)

The training process amounts to minimizing the loss component l_{D}(θ, ϕ) with respect to θ, and the loss component l_{G}(θ, ϕ) with respect to ϕ. This is equivalent to finding the saddle point max_{θ}min_{ϕ} [symbol] (θ, ϕ) in the case that l(θ, ϕ)=[− [symbol] (θ, ϕ), [symbol] (θ, ϕ)].
In this case, both loss components are functions of both the first parameters θ and the second parameters ϕ. Note that optimizing one of the loss components with respect to the numerical parameters (θ, ϕ) moves the other of the loss components away from its optimal value

In one form, the present disclosure relates to a process in which the parameter updating system 130 updates (θₖ, ϕₖ) in multiple time steps labelled by integer index k to minimize the objective function given by Eqn. (4). Typically, both the first parameters θ and the second parameters ϕ are updated at each time step, thus training both networks concurrently.

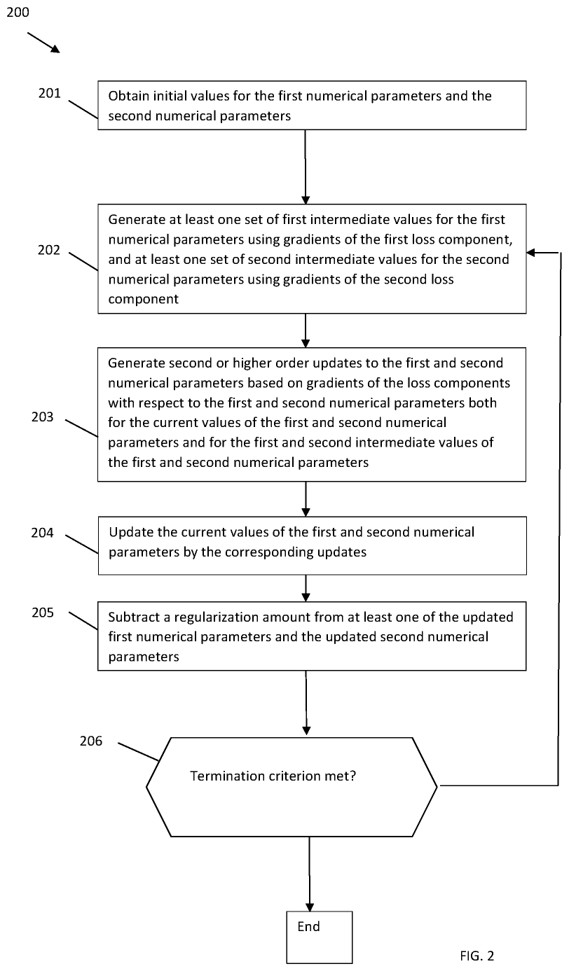

Turning to FIG. 2, a method 200 exemplifying the principles of this disclosure is shown. The method may be performed by a parameter updating system such as the parameter updating system 130 of FIG. 1. In a first step 201 of method 200, the parameter updating system obtains initial values for the first and second numerical parameters. These values may for example be random, or they may be predefined values.

In step 202, the parameter updating system performs at least one intermediate step in which it generates a set of first intermediate values \tilde{θ}ₖ for the first numerical parameters using gradients of the first loss component for the current values of the first and second numerical parameters, and a set of second intermediate values \tilde{φ}ₖ for the second numerical parameters using gradients of the second loss component for the current values of the first and second numerical parameters.

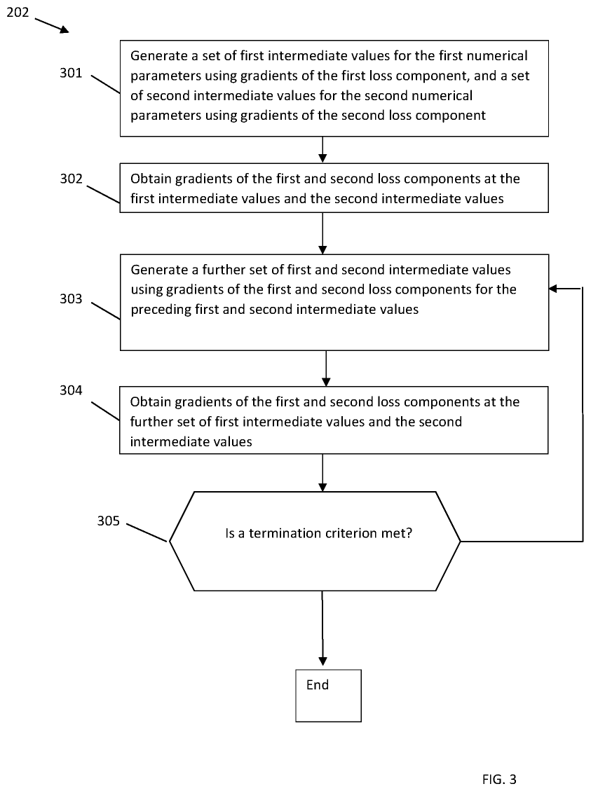

First a case is explained in which there is only one intermediate step (i.e. to generate one set of first and second intermediate values). The method 200 is in this case referred to as the “RK2” method. Below, with reference to FIG. 3, a case is explained in which there are multiple intermediate steps (e.g. three). However, when there is only one intermediate step, the first intermediate values \tilde{θ}ₖ for the first parameters, and second intermediate values \tilde{ϕ}ₖ for the second numerical parameters may be given by:

$$( \begin{matrix}{\tilde{θ}}_{k} \\ {\tilde{ϕ}}_{k}\end{matrix} ) = ( \begin{matrix}{θ}_{k} \\ {ϕ}_{k}\end{matrix} ) + h ν ( {θ}_{k} , {ϕ}_{k} ) \qquad ( 6 )$$

where the vector v(θₖ, φₖ) is given by

$$ν ( {θ}_{k} , {ϕ}_{k} ) = - [ α \frac{\partial {l}_{D}}{\partial θ} , β \frac{\partial {l}_{G}}{\partial ( f )} ]$$

evaluated at (θₖ, ϕₖ). The values α and β are constant real numbers.

In step 203, updates (that is respective update amounts) are obtained to the current values (θₖ, ϕₖ) of the first and second numerical parameters. These updates are second or higher order. That is, they are a function both of the current values of the first and second numerical values and also of the set(s) of first and second intermediate data. Thus, each update encodes and benefits from higher derivatives of the loss function. This improves the convergence of the algorithm, both in terms of speed (i.e. reduced computational resources required, or from another point of view improved final performance for a fixed amount of computational resources) and of avoiding being trapped in local minima such that the training algorithm fails completely.

In the case that there is only a single intermediate step, which as explained above produces one set of first and second intermediate values of Eqn. (6). This is used in step 203 to produce the two values called here “updates”

$$\frac{h}{2} ( α \frac{\partial {l}_{D}}{\partial θ} {\vert}_{{θ}_{k} , {ϕ}_{k}} + α \frac{\partial {l}_{D}}{\partial θ} {\vert}_{{\tilde{θ}}_{k} , {\tilde{ϕ}}_{k}} ) and \frac{h}{2} ( α \frac{\partial {l}_{G}}{\partial ϕ} {\vert}_{{θ}_{k} , {ϕ}_{k}} + α \frac{\partial {l}_{G}}{\partial ( f )} {\vert}_{{\tilde{θ}}_{k} , {\tilde{ϕ}}_{k}} ) .$$

These are components of the vector field

$$\frac{h}{2} ( v ( {θ}_{k} , {ϕ}_{k} ) + v ( {\tilde{θ}}_{k} , {\tilde{ϕ}}_{k} ) )$$

corresponding to θ and ϕ respectively.

In step 204, the current values of the first and second numerical parameters are updated by adding the respective updates, to give:

$$( \begin{matrix}{θ}_{k + 1} \\ {ϕ}_{k + 1}\end{matrix} ) = ( \begin{matrix}{θ}_{k} \\ {ϕ}_{k}\end{matrix} ) - + \frac{h}{2} ( v ( {θ}_{k} , {ϕ}_{k} ) + v ( {\tilde{θ}}_{k} , {\tilde{ϕ}}_{k} ) ) . \qquad ( 7 )$$

This update is analogous to Heun's method for solving ordinary differential equations (also known as a two-stage Runga Kutta method, or a Runga Kutta method of second order). It is second order because the update is based on values determined at two locations in the space of the variables (θ, ϕ).

In optional step 205, a regularization amount is subtracted from the new current values of the first and/or second numerical parameters. Specifically, the regularization may be applied only to the first numerical parameters, by removing the amount hλg_{θ} where λ is a regularization multiplier, and

$${g}_{θ} = {∇}_{Θ} {‖ \frac{\partial {l}_{G}}{\partial ϕ} {\vert}_{{θ}_{k} , {ϕ}_{k}} ‖}^{2} .$$

In step 206, it is determined whether a termination criterion is met (e.g. if the update values of Eqn. (7) had a magnitude below a predetermined threshold, or if a maximum number of iterations has been reached). If not, the value of k is increased by one, and the method returns to step 202. If it is, method 200 ends, and the most recently derived values of the second numerical parameters ϕₖ₊₁ are adopted as the parameters of the trained generator. The discriminator is typically only used in the training, and if so θₖ₊₁ may be discarded.

Turning now to FIG. 3, a more generalized way is explained in which the step 202 of the method 200 can be carried out, to generate more than one set of first and second intermediate values. In particular, the case is considered in which three sets of first and second intermediate values are generated (the “RK4” method”)

In sub-step 301 of step 202, first intermediate values are defined. This may be done by defining:

v₁=v(θₖ, φₖ) where again

$$ν ( {θ}_{k} , {ϕ}_{k} ) = - [ α \frac{\partial {l}_{D}}{\partial θ} , β \frac{\partial {l}_{G}}{\partial ϕ} ]$$

evaluated at (θₖ, ϕₖ). A first set of first and second intermediate values is derived as:

$$( {θ}_{k} + \frac{h}{2} {( {ν}_{1} )}_{θ} , {ϕ}_{k} + \frac{h}{2} {( {ν}_{1} )}_{ϕ} )$$

where (v₁)_{θ} denotes the vector field element corresponding to θ (that is,

$${( {ν}_{1} )}_{ϕ} = - [ α \frac{\partial {l}_{D}}{\partial θ} ]$$

evaluated at (θₖ, ϕₖ)), and (v₁)_{ϕ} denotes the vector field element corresponding to ϕ (that is,

$${( {ν}_{1} )}_{ϕ} = - [ β \frac{\partial {l}_{G}}{\partial ϕ} ]$$

evaluated at (θₖ, ϕₖ)).

At sub-step 302, gradients of the first and second loss components are obtained for the first and second intermediate values of the first and second numerical parameters:

$${ν}_{2} = ν ( {θ}_{k} + \frac{h}{2} {( {ν}_{1} )}_{θ} , {ϕ}_{k} + \frac{h}{2} {( {ν}_{1} )}_{ϕ} ) .$$

At sub-step 303, a further (second) set of intermediate values is generated using the gradient obtained at sub-step 302:

$$( {θ}_{k} + \frac{h}{2} {( {ν}_{2} )}_{θ} , {ϕ}_{k} + \frac{h}{2} {( {ν}_{2} )}_{ϕ} )$$

At sub-step 304, the gradients of the first and second loss components at the further set of intermediate values is obtained:

$${ν}_{3} = ν ( {θ}_{k} + \frac{h}{2} {( {ν}_{2} )}_{θ} , {ϕ}_{k} + \frac{h}{2} {( {ν}_{2} )}_{ϕ} )$$

In step 305 it is determined whether a termination criterion is met. In the case that the step 202 is used to obtain three sets of first and second intermediate values, it is not yet met. So the method returns, to step 303.

At sub-step 303, the second time it is performed, a further (second) set of intermediate values is generated using the gradient obtained at sub-step 302:

(θₖ+h(v₃)_{θ},ϕₖ+h(v₃)_{ϕ})

At sub-step 304, the gradients of the first and second loss components at the further set of intermediate values is obtained:

v₄=v(θₖ+h(v₃)_{θ},ϕₖ+h(v₃)_{ϕ})

This time, when the step 305 is reached, because all three sets of first and intermediate values have been obtained, the termination criterion is met. The method proceeds to step 304.

When step 203 is performed in this case, the updates to the first and second order numerical parameters are:

$$\frac{h}{6} ( {ν}_{1} + 2 {ν}_{2} + 2 {ν}_{3} + {ν}_{4} ) .$$

Thus, when step 204 is performed, the current values of the first and second numerical parameters are updated by the two update values, to give:

$$( \begin{matrix}{θ}_{k + 1} \\ {ϕ}_{k + 1}\end{matrix} ) = ( \begin{matrix}{θ}_{k} \\ {ϕ}_{k}\end{matrix} ) + \frac{h}{6} ( {ν}_{1} + 2 {ν}_{2} + 2 {ν}_{3} + {ν}_{4} ) .$$

This is analogous to the 4-th order Runge Kutta (RK4) method for solving ordinary differential equations. Steps 205 and 206 are performed in the same way as in the case explained above in which there is only one intermediate step.

Experimentally, it was found that both the 2^{nd} order (RK2) and the 4^{th} order (RK4) methods explained above lead to improved convergence compared to a first order iterative method, namely Euler's method. This was true although the expectation values of the loss function were obtained by Monte-Carlo sampling using mini-batches of samples, which introduced a noise into the calculation of the v vectors. Using a higher order also made it possible to use a larger step size h. Euler's method became unstable for h>0.04 while the RK2 and RK2 methods did not. However, it was also found that using a regularization multiplier A which was too low (e.g. around 0.001) reduced the improvement over the first order methods. A value higher than 0.002 was preferable, such as 0.005 or 0.01.

Although in the explanation of the disclosure given above a GAN has been described, the present techniques are applicable to training any adaptive system defined by numerical parameters which comprises one or more first numerical parameters and one or more second numerical parameters, and in which the training minimizes an objective function having a plurality of loss components, at least one of the loss components being a function of both the first and second numerical parameters, wherein optimizing one of the loss components with respect to the numerical parameters moves another of the loss components away from its optimal value. Actor-critic models are in this category, as are the adversarial models of proximal gradient TD learning, multi-level optimization, synthetic gradients, hierarchical reinforcement learning, curiosity learning, and imaginative networks. Once the loss function is written in the form of Eqn. (6), the remainder of method 200 above can be conducted without modifying the method 200.

In this document, references to evaluating the gradient of a function “for” certain values of parameters of the function means that the gradient of the function is evaluated when those parameters take those certain values.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method of training an adversarial model based on a plurality of numerical parameters, the numerical parameters comprising one or more first numerical parameters and one or more second numerical parameters, the training being performed to minimize an objective function having a plurality of loss components, at least one of the loss components being a function of both the first and second numerical parameters, wherein optimizing one of the loss components with respect to the numerical parameters tends to move another of the loss components away from its optimal value,
the method comprising repeatedly performing a second or higher order update operation at successive time steps, the second or higher order update operation comprising:
based on current values for the first and second numerical parameters, generating at least one set of first intermediate values for the first numerical parameters using gradients of the first loss component, and at least one set of second intermediate values for the second numerical parameters using gradients of the second loss component;
generating respective second or higher order updates to the first and second numerical parameters based on gradients of the loss components with respect to the first and second numerical parameters both for the current values of the first and second numerical parameters and for the first and second intermediate values of the first and second numerical parameters; and
updating the current values of the first and second numerical parameters by the corresponding updates.

2. The method of claim 1 in which said generating at least one set of first intermediate values for the first numerical parameters using gradients of the first loss component, and at least one set of second intermediate values for the second numerical parameters using gradients of the second loss component, is performed in one or more successive intermediate steps,
in each intermediate step, a set of intermediate values for the numerical parameters is generated comprising a respective said set of first intermediate values for the first numerical parameters and a respective said set of second intermediate values for the second numerical parameters.

3. The method of claim 2 in which, in the first intermediate step:
each first intermediate value is derived by adjusting the current value of the first numerical parameter by a respective amount indicative of the gradient of the first loss component with respect to the first numerical parameter for the current values of the numerical parameters, and
each second intermediate value is derived by adjusting the current value of the second numerical parameter by a respective amount indicative of the gradient of the second loss component with respect to the second numerical parameter for the current values of the numerical parameters.

4. The method of claim 2 in which there are a plurality of said intermediate steps, and each of the intermediate steps except the first comprises evaluating the gradient of the first loss component with respect to the first numerical parameters and the gradient of the second loss component with respect to the second numerical parameters, each of the evaluations being performed for the intermediate values generated in the preceding intermediate step.

5. The method of claim 2 in which:
the update for each first numerical parameter is a sum of a term indicative of the gradient of the first loss component with respect to the first numerical parameter for the current values of the numerical parameters, and, for each of the intermediate steps, a term indicative of the gradient the first loss component with respect to the first numerical parameter for the corresponding intermediate values of the numerical parameters; and
the update for each second numerical parameter is a sum of a term indicative of the gradient of the second loss component with respect to the second numerical parameter for the current values of the numerical parameters, and, for each of the intermediate steps, a term indicative of the gradient of the second loss component with respect to the second numerical parameter for the corresponding intermediate values of the numerical parameters.

6. The method of claim 2 in which there is only one said intermediate step, and
the update for each first numerical parameter is indicative of the average of (i) the gradient of the first loss component with respect to the first numerical parameter for the current values of the numerical parameters, and (ii) the gradient the first loss component with respect to the first numerical parameter for the set of intermediate values of the numerical parameters; and
the update for each second numerical parameter is indicative of the average of (i) the gradient of the second loss component with respect to the second numerical parameter for the current values of the numerical parameters, and (ii) the gradient the second loss component with respect to the second numerical parameter for the set of intermediate values of the numerical parameters.

7. The method of claim 5 in which there are a plurality of intermediate steps, and in each intermediate step but the first:
each first intermediate value is derived by adjusting the current value of the first numerical parameter by a respective amount indicative of the gradient of the first loss component with respect to the first numerical parameter for the set of intermediate values of the numerical parameters derived in the preceding intermediate step, and
each second intermediate value is derived by adjusting the current value of the second numerical parameter by a respective amount indicative of the gradient of the second loss component with respect to the second numerical parameter for the set of intermediate values of the numerical parameters derived in the preceding intermediate step

8. The method of claim 7 in which there are three intermediate steps, and
the update for each first numerical parameter is indicative of the average of (i) the gradient of the first loss component with respect to the first numerical parameter for the current values of the numerical parameters, (ii) twice the gradient the first loss component with respect to the first numerical parameter for the first set of intermediate values of the numerical parameters, (iii) twice the gradient the first loss component with respect to the first numerical parameter for the second set of intermediate values of the numerical parameters; and (iv) the gradient the first loss component with respect to the first numerical parameter for the third set of intermediate values of the numerical parameters; and
the update for each second numerical parameter is indicative of the average of (i) the gradient of the second loss component with respect to the second numerical parameter for the current values of the numerical parameters, (ii) twice the gradient the second loss component with respect to the second numerical parameter for the first set of intermediate values of the numerical parameters, (iii) twice the gradient the second loss component with respect to the second numerical parameter for the second set of intermediate values of the numerical parameters; and (iv) the gradient the second loss component with respect to the second numerical parameter for the third set of intermediate values of the numerical parameters.

9. The method of claim 1 in which the update process further comprises a regularization update, to at least one of the first numerical parameters and the second numerical parameters, the regularization update being performed by subtracting a regularization amount from the corresponding one of the updated first numerical parameters and the updated second numerical parameters.

10. The method of claim 9 in which the regularization amount is a positive number, the number being indicative in the case of the first numerical parameters of the magnitude of gradient of the first loss component with respect to the first numerical parameters for the updated numerical parameters, and in the case of the second numerical parameters of the magnitude of the gradient of the second loss component with respect to the second numerical parameters for the updated numerical parameters.

11. The method of claim 10 in which the regularization amount, in the case of the first numerical parameters is proportional to the square of the gradient of the first loss component with respect to the first numerical parameters for the current numerical parameters, and in the case of the second numerical parameters is proportional to the square the gradient of the second loss component with respect to the second numerical parameters for the current numerical parameters.

12. The method of claim 1 in which the adaptive system comprises a generative neural network configured to generate samples based on one or more latent values, and a discriminator neural network configured to distinguish between samples generated by the generative neural network and samples from a sample distribution which are not generated by the generative neural network.

13. The method of claim 12 in which the discriminator neural network is defined by the first numerical parameters, and the generative neural network defined by the second numerical parameters.

14. The method of claim 13 in which both the loss components are indicative of a sum of (i) an average over the distribution of the latent values of a term indicative of the output of the discriminator network upon receiving as an input the output of the generative neural network generated based on the latent values, and (ii) an average over a training set of data items of a term indicative of the output of the discriminator network upon receiving as an input a data item from the training set.

15. The method of claim 14 which the minimizing the first loss component with respect to the first parameters corresponds to maximizing a measure of a difference between (i) an average over the distribution of the latent values of a term indicative of the output of the discriminator network upon receiving as an input the output of the generative neural network generated based on the latent values, and (ii) an average over a training set of data items of a term indicative of the output of the discriminator network upon receiving as an input a data item from the training set,
and minimizing the second loss component with respect to the second parameters corresponds to minimizing said measure of the difference.

16. The method of claim 13, in which the update process further comprises a regularization update to the second numerical parameters, the regularization update being performed by subtracting a regularization amount from the updated second numerical parameters.

17. The method of claim 1 in which the first and second loss components are both functions of both the first and second numerical parameters.

18. A system comprising one or more computers and one or more storage devices storing instructions that when executed by the one or more computers cause the one or more computers to perform train an adversarial model based on a plurality of numerical parameters, the numerical parameters comprising one or more first numerical parameters and one or more second numerical parameters, the training being performed to minimize an objective function having a plurality of loss components, at least one of the loss components being a function of both the first and second numerical parameters, wherein optimizing one of the loss components with respect to the numerical parameters moves another of the loss components away from its optimal value,
the instructions causing the one or more computers to repeatedly perform at successive time steps a second or higher order update operation to current values of the first and second numerical parameters, the second or higher order update operation comprising:
based on the current values for the first and second numerical parameters, generating at least one set of first intermediate values for the first numerical parameters using gradients of the first loss component, and at least one set of second intermediate values for the second numerical parameters using gradients of the second loss component;
generating respective second or higher order updates to the first and second numerical parameters based on gradients of the loss components with respect to the first and second numerical parameters both for the current values of the first and second numerical parameters and for the first and second intermediate values of the first and second numerical parameters; and
updating the current values of the first and second numerical parameters by the corresponding updates at successive time steps.

19. One or more computer storage media storing instructions that when executed by one or more computers cause the one or more computers to train an adversarial model based on a plurality of numerical parameters, the numerical parameters comprising one or more first numerical parameters and one or more second numerical parameters, the training being performed to minimize an objective function having a plurality of loss components, at least one of the loss components being a function of both the first and second numerical parameters, wherein optimizing one of the loss components with respect to the numerical parameters moves another of the loss components away from its optimal value,
the instructions causing the one or more computers to repeatedly perform at successive time steps a second or higher order update operation to current values of the first and second numerical parameters, the second or higher order update operation comprising:
based on the current values for the first and second numerical parameters, generating at least one set of first intermediate values for the first numerical parameters using gradients of the first loss component, and at least one set of second intermediate values for the second numerical parameters using gradients of the second loss component;
generating respective second or higher order updates to the first and second numerical parameters based on gradients of the loss components with respect to the first and second numerical parameters both for the current values of the first and second numerical parameters and for the first and second intermediate values of the first and second numerical parameters; and
updating the current values of the first and second numerical parameters by the corresponding updates.
